(19) United States
(12) Patent Application Publication
(10) Pub. No.: US 2025/0153693 A1
(43) Pub. Date: May 15, 2025

(54) VEHICLE BRAKING CONTROL DEVICE

(71) Applicant: ADVICS CO., LTD., Kariya-shi, Aichi-ken (JP)

(72) Inventors: Takashi EBINE, Kariya-shi, Aichi-ken (JP); Shunya WATANABE, Kariya-shi, Aichi-ken (JP)

(73) Assignee: ADVICS CO., LTD., Kariya-shi, Aichi-ken (JP)

(21) Appl. No.: 18/835,292

(22) PCT Filed: Feb. 15, 2023
(86) PCT No.: PCT/JP2023/005211

§ 371 Date: Aug. 1, 2024

(30) Foreign Application Priority Data
Feb. 21, 2022 (JP) 2022-024487

(51) Int. Cl. B60T 8/26; B60T 8/176; B60T 17/22

(52) U.S. Cl. CPC B60T 8/26; B60T 8/176; B60T 17/22

(57) ABSTRACT

A vehicle braking control device includes supply and servo chambers sealed by a seal member, a pressure adjustment unit that adjusts front wheel pressure by supplying a first servo pressure to the servo chamber and outputs front wheel supply pressure from the supply chamber to a front wheel cylinder, and adjusts rear wheel pressure by outputting a second servo pressure to a rear wheel cylinder as rear wheel supply pressure, front/rear wheel supply pressure sensors that detect the front/rear wheel supply pressures respectively, and a controller that selects any one of a two-system pressure adjustment for individually adjusting the first and second servo pressures, and a one-system pressure adjustment for adjusting the first and second servo pressures to be the same. The controller individually calculates front/rear wheel target pressures and causes the front/rear wheel supply pressures to coincide with the front/rear wheel target pressures in the two-system pressure adjustment

### TECHNICAL FIELD

The present disclosure relates to a vehicle braking control device.

### BACKGROUND ART

The applicant has developed a braking control device in which a dimension in a longitudinal direction is reduced, and a braking liquid pressure of a front wheel system and a braking liquid pressure of a rear wheel system are individually controlled, as described in PTL 1. In this device, a two-system pressure adjustment in which the braking liquid pressures of the front wheel and rear wheel systems are individually controlled may be switched to a one-system pressure adjustment in which the braking liquid pressures of the front wheel and rear wheel systems are controlled to be the same. For this switching, smoothness is required.

### CITATION LIST

### Patent Literature

PTL 1: JP2019-137202A

### SUMMARY

### Technical Problem

An object of the present disclosure is to provide a vehicle braking control device capable of smoothly performing a switching from a two-system pressure adjustment to a one-system pressure adjustment.

### Solution to Problem

A vehicle braking control device (SC) according to the present disclosure adjusts liquid pressures (Pwf, Pwr) of front wheel and rear wheel cylinders (CWf, CWr) according to a braking required amount (Bs), and includes “an applying unit (AP) including a cylinder (CM), and a supply chamber (Rm) and a servo chamber (Ru) partitioned by a piston (NM) inserted into the cylinder (CM) and sealed by a seal member (SL)”; “a pressure adjustment unit (CA) configured to electrically adjust first and second servo pressures (P1, P2), adjust the liquid pressure (Pwf) of the front wheel cylinder (CWf) by supplying the first servo pressure (P1) to the servo chamber (Ru) and outputting a front wheel supply pressure (Pm) from the supply chamber (Rm) to the front wheel cylinder (CWf), and adjust the liquid pressure (Pwr) of the rear wheel cylinder (CWr) by outputting the second servo pressure (P2) to the rear wheel cylinder (CWr) as a rear wheel supply pressure (Pv)”; “front wheel and rear wheel supply pressure sensors (PM, PV) configured to detect the front wheel and rear wheel supply pressures (Pm, Pv) respectively”; and “a controller (EA) configured to select any one of a two-system pressure adjustment for individually adjusting the first and second servo pressures (P1, P2), and a one-system pressure adjustment for adjusting the first and second servo pressures (P1, P2) to be the same”.

In the vehicle braking control device (SC) according to the present disclosure, in response to selection of the two-system pressure adjustment, the controller (EA) individually calculates front wheel and rear wheel target pressures (Ptf, Ptr) based on the braking required amount (Bs), and controls the pressure adjustment unit (CA) such that the front wheel and rear wheel supply pressures (Pm, Pv) coincide with the front wheel and rear wheel target pressures (Ptf, Ptr). On the other hand, in response to selection of the one-system pressure adjustment, the controller (EA) makes the front wheel and rear wheel target pressures (Ptf, Ptr) equal and then adds a predetermined pressure (ps) to calculate a common target pressure (Px), and controls the pressure adjustment unit (CA) such that the rear wheel supply pressure (Pv) coincides with the common target pressure (Px). For example, the predetermined pressure (ps) is set to a value corresponding to sliding resistance of the seal member (SL). The controller (EA) switches the two-system pressure adjustment to the one-system pressure adjustment at a time point when execution of an antilock brake control is started.

In the braking control device SC, the rear wheel supply pressure Pv is used for a control of the one-system pressure adjustment, and the predetermined pressure ps is added to the common target pressure Px of the one-system pressure adjustment so as to compensate for a friction resistance of the seal member SL. According to the above configuration, the switching from the two-system pressure adjustment to the one-system pressure adjustment is smoothly performed.

### BRIEF DESCRIPTION OF DRAWINGS

FIG. 1 is a schematic diagram for illustrating an overall configuration of a vehicle JV equipped with a braking control device SC according to the present disclosure.

FIG. 2 is a schematic diagram for illustrating a configuration example of an upper braking unit SA.

FIG. 3 is a flowchart for illustrating a processing example of a pressure adjustment control.

FIG. 4 is a block diagram for illustrating a drive control example of upstream side and downstream side pressure adjustment valves UJ, UK in a two-system pressure adjustment.

FIG. 5 is a block diagram for illustrating a drive control example of the downstream side pressure adjustment valve UK in a one-system pressure adjustment.

### DESCRIPTION OF EMBODIMENTS

### <Symbols of Constituent Members or the Like and Subscripts at the End of Symbols>

In the following description, constituent members, calculation processing, signals, characteristics, and values denoted by the same symbols, such as “CW”, have the same function. Subscripts “f” and “r” added to the end of the symbols related to respective wheels are comprehensive symbols indicating which system of the front and rear wheels these subscripts relate to. For example, wheel cylinders CW provided in wheels are expressed as a “front wheel cylinder CWf” and a “rear wheel cylinder CWr”. Furthermore, the subscripts “f” and “r” at the end of the symbols can be omitted. When the subscripts “f” and “r” are omitted, each symbol represents a generic term. For example, “CW” is a generic term for wheel cylinders provided in front and rear wheels of a vehicle.

In a fluid passage from a master cylinder CM to the wheel cylinders CW, a side close to the master cylinder CM (a side far from the wheel cylinders CW) is referred to as an “upper portion”, and a side close to the wheel cylinders CW (a side far from the master cylinder CM) is referred to as a “lower portion”. In a circulation flow KN of a braking liquid BF, a side close to a discharge portion of a fluid pump QA (a side away from a suction portion) is referred to as an “upstream side”, and a side close to the suction portion of the fluid pump QA (a side away from the discharge portion) is referred to as a “downstream side”.

An upper fluid unit YA (also referred to as an “upper actuator”) of an upper braking unit SA, a lower fluid unit YB (also referred to as a “lower actuator”) of a lower braking unit SB, and the wheel cylinders CW are connected by the fluid passage (a communication passage HS). Furthermore, in the upper and lower actuators YA, YB, various components (UJ, UK, and the like) are connected by the fluid passage. Here, the “fluid passage” is a passage for moving the braking liquid BF, and includes piping, a flow passage in an actuator, a hose, and the like. In the following description, the communication passage HS, a reflux passage HK, a reservoir passage HR, an input passage HN, a servo passage HV, and the like are fluid passages.

<Vehicle JV Equipped with Braking Control Device SC>

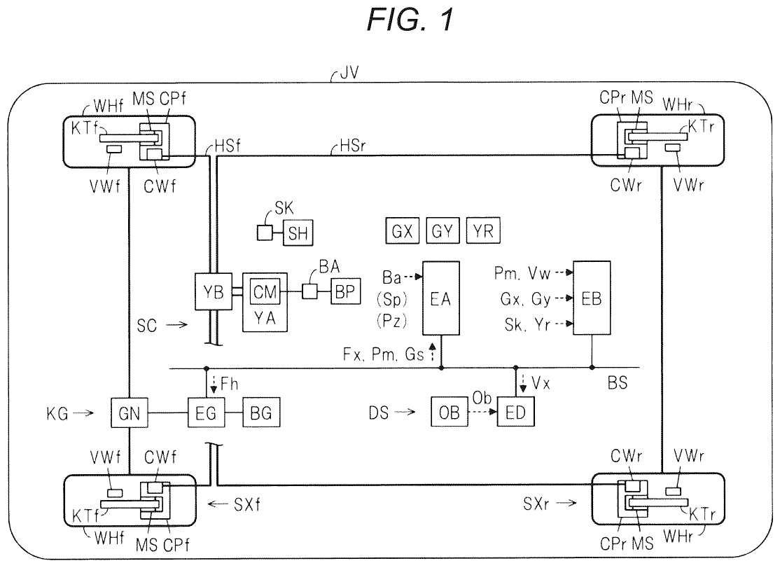

An overall configuration of a vehicle JV equipped with a braking control device SC according to the present disclosure will be described with reference to a schematic diagram of FIG. 1. The vehicle JV is a hybrid vehicle including an electric motor for driving, or an electric automatic vehicle. The vehicle JV includes a regeneration device KG. The regeneration device KG includes a generator GN and a control unit EG for the regeneration device (also referred to as a “regeneration controller”). The generator GN is also an electric motor for driving. In regenerative braking, the electric motor/generator GN operates as a power generator, and the generated power is stored in a storage battery BG via the regeneration controller EG. For example, the regeneration device KG is provided in front wheels WHf. In this configuration, a regenerative braking force Fg is generated in the front wheels WHf by the regeneration device KG.

Furthermore, the vehicle JV is provided with a driving assistance device DS in such a manner that a control for automatically stopping the vehicle (referred to as “automatic braking control”) is executed via the braking control device SC instead of a driver or by assisting the driver. The driving assistance device DS includes a distance sensor OB and a control unit ED (also referred to as a “driving assistance controller”) for the driving assistance device. A distance Ob (a relative distance) between an object (another vehicle, a fixed object, a person, a bicycle, a stop line, a sign, a signal, or the like) existing in front of the own vehicle JV and the own vehicle JV is detected by the distance sensor OB, and is input to the driving assistance controller ED. In the driving assistance controller ED, a required deceleration Gs for automatically stopping the vehicle JV is calculated based on the relative distance Ob. The required deceleration Gs is a target value of a vehicle deceleration for executing the automatic braking control. The required deceleration Gs is output to a communication bus BS.

The vehicle JV includes front wheel and rear wheel braking devices SXf, SXr (=SX). The braking device SX includes a brake caliper CP, a friction member MS (for example, a brake pad), and a rotating member KT (for example, a brake disc). The brake caliper CP is provided with the wheel cylinder CW. Due to a liquid pressure Pw (referred to as “wheel pressure”) in the wheel cylinder CW, the friction member MS is pressed against the rotating member KT fixed to each wheel WH. Accordingly, a friction braking force Fm is generated in the wheel WH. The “friction braking force Fm” is a braking force generated by the wheel pressure Pw.

The vehicle JV includes a braking operation member BP, a steering operation member SH, and various sensors (BA and the like). The braking operation member BP (for example, a brake pedal) is a member operated by a driver to decelerate the vehicle JV. The steering operation member SH (for example, a steering wheel) is a member operated by the driver to turn the vehicle JV.

The vehicle JV includes various sensors listed below. Detection signals (Ba and the like) of these sensors are input to one of upper and lower controllers EA and EB. In the upper and lower controllers EA and EB, various controls are executed based on the sensor signals.
A braking operation amount sensor BA that detects an operation amount Ba (a braking operation amount) of the braking operation member BP is provided. For example, an operation displacement sensor SP that detects an operation displacement Sp of the braking operation member BP is provided as the braking operation amount sensor BA. In addition, a simulator pressure sensor PZ that detects a liquid pressure Pz (referred to as a “simulator pressure”) of a stroke simulator SS is employed. In the braking control device SC, the braking operation amount Ba is a generic term for signals indicating a braking intention of the driver, and the braking operation amount sensor BA is a generic term for sensors that detect the braking operation amount Ba. The braking operation amount Ba is input to the upper controller EA.
A wheel speed sensor VW that detects a rotation speed Vw (a wheel speed) of the wheel WH is provided. The wheel speed Vw is input to the lower controller EB. In the lower controller EB, a vehicle body speed Vx is calculated based on the wheel speed Vw. In the lower controller EB, based on the wheel speed Vw and the vehicle body speed Vx, an antilock brake control (an ABS control) for preventing the wheels WH from being locked and a traction control for preventing idling of the drive wheel WH are executed.
A steering operation amount sensor SK that detects an operation amount Sk (a steering operation amount, for example, a steering angle) of the steering operation member SH is provided. The vehicle JV (in particular, a vehicle body) is provided with a yaw rate sensor YR that detects a yaw rate Yr, a longitudinal acceleration sensor GX that detects a longitudinal acceleration Gx, and a lateral acceleration sensor GY that detects a lateral acceleration Gy. These sensor signals are input to the lower controller EB. In the lower controller EB, oversteer and understeer are prevented based on these signals (Sk, Yr, Gy, and the like), and an electronic stability control (ESC) that stabilizes a yawing behavior of the vehicle JV is executed.

The vehicle JV includes the braking control device SC. In the braking control device SC, a front-rear type (also referred to as “II type”) is adopted for the two braking systems. The actual wheel pressure Pw is adjusted by the braking control device SC.

The braking control device SC includes the two braking units SA and SB. The upper braking unit SA includes the upper actuator YA (the upper fluid unit) and the upper controller EA (an upper control unit). The upper actuator YA is controlled by the upper controller EA. The lower braking unit SB is disposed between the upper braking unit SA and the wheel cylinder CW. The lower braking unit SB includes the lower actuator YB (the lower fluid unit) and the lower controller EB (a lower control unit). The lower actuator YB is controlled by the lower controller EB.

The upper braking unit SA (in particular, the upper controller EA), the lower braking unit SB (in particular, the lower controller EB), the regeneration device KG (in particular, the regeneration controller EG), and the driving assistance device DS (in particular, the driving assistance controller ED) are connected to the communication bus BS. The “communication bus BS” has a network structure in which a plurality of controllers (control units) are suspended from a communication line. Signal transmission is performed between a plurality of controllers (EA, EB, EG, ED, and the like) by the communication bus BS. That is, the plurality of controllers can transmit signals (detection values, calculation values, control flags, and the like) to the communication bus BS, and can receive the signals from the communication bus BS.

### <Upper Braking Unit SA>

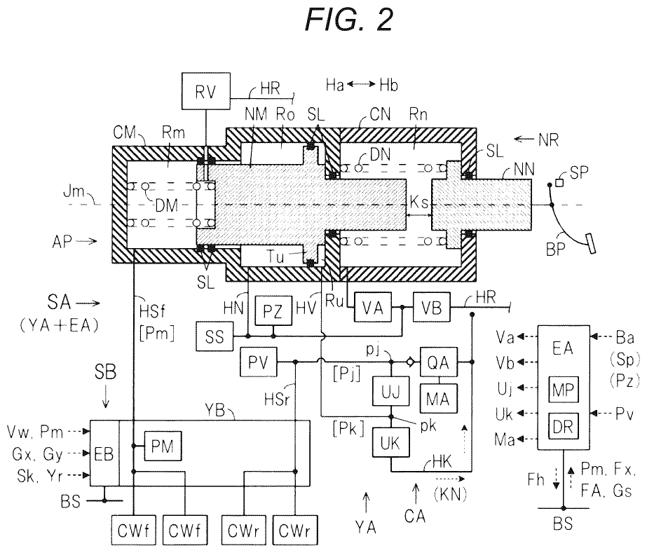

A configuration example of the upper braking unit SA of the braking control device SC will be described with reference to a schematic diagram of FIG. 2. The upper braking unit SA generates front wheel and rear wheel supply pressures Pm, Pv according to an operation of the braking operation member BP (a brake pedal). The front wheel and rear wheel supply pressures Pm, Pv are finally supplied to the front wheel and rear wheel cylinders CWf, CWr via the communication passage HS (the fluid passage) and the lower braking unit SB. That is, liquid pressures Pwf, Pwr (front wheel and rear wheel pressures) of the front wheel and rear wheel cylinders CWf, CWr are adjusted by the front wheel and rear wheel supply pressures Pm, Pv. The upper braking unit SA includes the upper actuator YA and the upper controller EA.

### <<Upper Actuator YA>>

The upper actuator YA includes an applying unit AP, a pressure adjustment unit CA, and an input unit NR.

### [Applying Unit AP]

The front wheel supply pressure Pm is output from the applying unit AP. The applying unit AP includes the single type master cylinder CM and a master piston NM.

The master piston NM is inserted into the single type master cylinder CM. The inside of the master cylinder CM is partitioned into three liquid pressure chambers Rm, Ru, and Ro by the master piston NM. The master chamber Rm (also referred to as a “supply chamber”) is defined by one side bottom of the master cylinder CM and the master piston NM. Furthermore, the inside of the master cylinder CM is partitioned into the servo chamber Ru and the reaction force chamber Ro by a flange portion Tu of the master piston NM. That is, the master chamber Rm and the servo chamber Ru are arranged to face each other with the flange portion Tu in between. The liquid pressure chambers Rm, Ru, and Ro are sealed by seal members SL. Therefore, when the master piston NM is moved, a frictional force is generated between each of the seal member SL and a surface (a sliding surface) on which the seal member SL slides. A pressure receiving area rm of the master chamber Rm and a pressure receiving area ru of the servo chamber Ru are made equal.

At the time of non-braking, the master piston NM is at a most retreating position (that is, a position at which a volume of the master chamber Rm becomes maximum). In this state, the master chamber Rm of the master cylinder CM communicates with a master reservoir RV. The braking liquid BF is stored in the master reservoir RV (an atmospheric pressure reservoir). When the braking operation member BP is operated, the master piston NM is moved in a forward direction Ha (a direction in which the volume of the master chamber Rm decreases). The communication between the master chamber Rm and the master reservoir RV is blocked by the movement. When the master piston NM is further moved in the forward direction Ha, the front wheel supply pressure Pm is increased from “0 (an atmospheric pressure)”. Accordingly, the braking liquid BF pressurized to the front wheel supply pressure Pm from the master chamber Rm (supply chamber) of the master cylinder CM is output (pumped). The front wheel supply pressure Pm is a liquid pressure in the master chamber Rm, and thus the front wheel supply pressure Pm is also referred to as a “master pressure”.

### [Pressure Adjustment Unit CA]

The pressure adjustment unit CA supplies the rear wheel supply pressure Pv to the rear wheel cylinder CWr, and supplies a downstream side servo pressure Pk to the servo chamber Ru of the applying unit AP. The pressure adjustment unit CA includes an electric motor MA, the fluid pump QA, and the upstream side and downstream side pressure adjustment valves UJ, UK.

The fluid pump QA is driven by the electric motor MA. In the fluid pump QA, the suction portion and the discharge portion are connected to each other by the reflux passage HK (the fluid passage). The suction portion of the fluid pump QA is also connected to the master reservoir RV via the reservoir passage HR. A check valve is provided at the discharge portion of the fluid pump QA.

The two pressure adjustment valves UJ, UK are provided in series in the reflux passage HK. Specifically, the reflux passage HK is provided with the normally open type downstream side pressure adjustment valve UK. The normally open type upstream side pressure adjustment valve UJ is provided between the downstream side pressure adjustment valve UK and the discharge portion of the fluid pump QA. Therefore, in the circulation flow KN of the braking liquid BF, the upstream side pressure adjustment valve UJ is disposed on the upstream side (the side close to the discharge portion of the fluid pump QA) with respect to the downstream side pressure adjustment valve UK. The upstream side and downstream side pressure adjustment valves UJ, UK are linear type solenoid valves in which a valve opening amount (lift amount) is continuously controlled based on an energization state (for example, supply currents Ij, Ik). The upstream side and downstream side pressure adjustment valves UJ, UK adjust a difference in the liquid pressures (a differential pressure) between the upstream side and the downstream side, and thus the upstream side and downstream side pressure adjustment valves UJ, UK are also referred to as “differential pressure valves”.

When the fluid pump QA is driven by the electric motor MA, the circulation flow KN (indicated by a broken line arrow) of the braking liquid BF including the fluid pump QA and the upstream side and downstream side pressure adjustment valves UJ, UK is generated in the reflux passage HK. The liquid pressure Pk (referred to as the “downstream side servo pressure”) between the upstream side pressure adjustment valve UJ and the downstream side pressure adjustment valve UK is controlled by the downstream side pressure adjustment valve UK. A liquid pressure Pj (referred to as the “upstream side servo pressure”) between the upstream side pressure adjustment valve UJ and the discharge portion of the fluid pump QA is controlled by the upstream side pressure adjustment valve UJ.

When the downstream side pressure adjustment valve UK is in a fully open state (at the time of non-energization as the downstream side pressure adjustment valve UK is of a normally open type), the downstream side servo pressure Pk is “0 (the atmospheric pressure)”. When an energization amount (the supply current Ik) to the downstream side pressure adjustment valve UK is increased, the circulation flow KN (the flow of the braking liquid BF circulating in the reflux passage HK) is throttled by the downstream side pressure adjustment valve UK. In other words, the flow passage of the reflux passage HK is narrowed by the downstream side pressure adjustment valve UK, and an orifice effect due to the downstream side pressure adjustment valve UK is exhibited. Accordingly, a differential pressure sPk (referred to as a “downstream side differential pressure”) is generated between the downstream side liquid pressure (the atmospheric pressure) and the upstream side liquid pressure Pk (referred to as the “downstream side servo pressure”) with respect to the downstream side pressure adjustment valve UK. The downstream side differential pressure sPk is adjusted according to the energization amount (the supply current Ik) to the downstream side pressure adjustment valve UK.

Similarly, when the upstream side pressure adjustment valve UJ is in the fully open state (at the time of non-energization as the upstream side pressure adjustment valve UJ is of the normally open type), the upstream side servo pressure coincides with the downstream side servo pressure Pk. When the energization amount (the supply current Ij) to the upstream side pressure adjustment valve UJ is increased, the circulation flow KN (the flow of the braking liquid BF circulating in the reflux passage HK) is throttled by the upstream side pressure adjustment valve UJ. In other words, the flow passage of the reflux passage HK is narrowed by the upstream side pressure adjustment valve UJ, and the orifice effect due to the upstream side pressure adjustment valve UJ is exhibited. Accordingly, a differential pressure sPj (referred to as the “upstream side differential pressure”) is generated between the downstream side liquid pressure Pk (the downstream side servo pressure) and the upstream side liquid pressure Pj (the upstream side servo pressure) with respect to the upstream side pressure adjustment valve UJ. The upstream side differential pressure sPj is adjusted according to the energization amount (the supply current Ij) to the upstream side pressure adjustment valve UJ. In a magnitude relationship between the upstream side servo pressure Pj and the downstream side servo pressure Pk, the upstream side servo pressure Pj is normally equal to or higher than the downstream side servo pressure Pk (that is, “Pj≥Pk”). Here, when the power is not supplied to the upstream side pressure adjustment valve UJ and the upstream side pressure adjustment valve UJ is in the fully open state, the upstream side servo pressure Pj and the downstream side servo pressure Pk are made equal (that is, “Pj=Pk”).

The liquid pressure supplied from the upper braking unit SA to the lower braking unit SB is referred to as the “supply pressure”. In the braking control device SC, a transmission passage of the supply pressure is different between a braking system related to the front wheels WHf and a braking system related to rear wheels WHr. In the braking system related to the front wheels WHf, the reflux passage HK is connected to the servo chamber Ru via the servo passage HV (fluid passage) at a portion pk between the upstream side pressure adjustment valve UJ and the downstream side pressure adjustment valve UK. Therefore, the downstream side servo pressure Pk is introduced (supplied) into the servo chamber Ru. As the downstream side servo pressure Pk increases, the master piston NM is pressed in the forward direction Ha, and the internal liquid pressure Pm (the front wheel supply pressure) of the master chamber Rm (supply chamber) is increased. A front wheel communication passage HSf is connected to the master chamber Rm. The front wheel communication passage HSf is connected to the front wheel cylinders CWf via the lower braking unit SB (in particular, the lower actuator YB). Therefore, in the braking system related to the front wheels WHf of the braking device SC, the downstream side servo pressure Pk is supplied to the front wheel cylinders CWf via the master cylinder CM as the front wheel supply pressure Pm. However, since “ru=rm” is satisfied, “Pk=Pm=Pwf” is satisfied. That is, the front wheel supply pressure Pm (finally, the front wheel pressure Pwf) is adjusted by the downstream side servo pressure Pk.

In the braking system related to the rear wheels WHr, the reflux passage HK is connected to the rear wheel cylinders CWr via a rear wheel communication passage HSr (the fluid passage) and the lower braking unit SB (in particular, the lower actuator YB) at a portion pj between the discharge portion of the fluid pump QA and the upstream side pressure adjustment valve UJ. Therefore, in the braking system related to the rear wheels WHr of the braking control device SC, the upstream side servo pressure Pj is directly supplied to the rear wheel cylinders CWr as the rear wheel supply pressure Pv (that is, Pj=Pv=Pwr). That is, the rear wheel supply pressure Pv (finally, the rear wheel pressure Pwr) is adjusted by the upstream side servo pressure Pj.

A rear wheel supply pressure sensor PV (also referred to as a “servo pressure sensor”) is provided in the rear wheel communication passage HSr to detect the rear wheel supply pressure Pv (=Pj). The rear wheel supply pressure sensor PV is connected to the upper controller EA. Therefore, a signal of the rear wheel supply pressure Pv is directly input to the upper controller EA.

### [Input Unit NR]

The braking operation member BP is operated by the input unit NR so as to achieve a regenerative coordination control, but a state in which the wheel pressure Pw is not generated is formed. The “regenerative coordination control” is to cause the friction braking force Fm (the braking force generated by the wheel pressure Pw) and the regenerative braking force Fg (the braking force generated by the generator GN) to work together such that kinetic energy of the vehicle JV can be efficiently recovered into electric energy during the braking. The input unit NR includes an input cylinder CN, an input piston NN, an introduction valve VA, a release valve VB, the stroke simulator SS, and the simulator pressure sensor PZ.

The input cylinder CN is fixed to the master cylinder CM. The input piston NN is inserted into the input cylinder CN. The input piston NN is mechanically connected to the braking operation member BP via a clevis (U-shaped link) so as to be interlocked with the braking operation member BP (brake pedal). An end surface of the input piston NN and an end surface of the master piston NM have a gap Ks (also referred to as a “separation displacement”). By adjusting the gap Ks by the downstream side servo pressure Pk, the regenerative coordination control is achieved.

An input chamber Rn of the input unit NR is connected to the reaction force chamber Ro of the applying unit AP via the input passage HN (the fluid passage). The normally closed type introduction valve VA is provided in the input passage HN. The input passage HN is connected to the master reservoir RV via the reservoir passage HR between the introduction valve VA and the reaction force chamber Ro. The reservoir passage HR is provided with the normally open type release valve VB. The introduction valve VA and the release valve VB are on-off type solenoid valves. The stroke simulator SS (also simply referred to as the “simulator”) is connected to the input passage HN between the introduction valve VA and the reaction force chamber Ro.

When the power supply to the introduction valve VA and the release valve VB is not performed, the introduction valve VA is closed and the release valve VB is opened. The input chamber Rn is sealed by the closing of the introduction valve VA, and the fluid is locked. Accordingly, the master piston NM is displaced integrally with the braking operation member BP. The simulator SS communicates with the master reservoir RV by opening the release valve VB. When power supply to the introduction valve VA and the release valve VB is performed, the introduction valve VA is opened, and the release valve VB is closed. Accordingly, the master piston NM can be separately displaced from the braking operation member BP. In this case, since the input chamber Rn is connected to the stroke simulator SS, an operation force Fp of the braking operation member BP is generated by the simulator SS. The simulator pressure sensor PZ is provided in the input passage HN between the introduction valve VA and the reaction force chamber Ro so as to detect the liquid pressure Pz (the simulator pressure) in the simulator SS. Note that since the simulator pressure Pz is also an internal pressure of the input chamber Rn, the simulator pressure Pz is also a state quantity representing the operation force Fp of the braking operation member BP.

A state in which the master piston NM and the braking operation member BP are separately displaced from each other (at the time of energization of the solenoid valves VA and VB) is referred to as a “first mode (or a by-wire mode)”. In the first mode, the braking control device SC functions as a brake-by-wire type device (that is, a device capable of generating the friction braking force Fm independently with respect to a braking operation of the driver). Therefore, in the first mode, the wheel pressure Pw is generated independently of the operation of the braking operation member BP. On the other hand, a state in which the master piston NM and the braking operation member BP are integrally displaced (at the time of non-energization of the solenoid valves VA and VB) is referred to as a “second mode (or a manual mode)”. In the second mode, the wheel pressure Pw is linked to the braking operation of the driver. In the input unit NR, one operation mode of the first mode (the by-wire mode) and the second mode (the manual mode) is selected based on the presence or absence of the power supply to the introduction valve VA and the release valve VB.

### <<Upper Controller EA>>

The upper actuator YA is controlled by the upper controller EA. The upper controller EA includes a microprocessor MP and a drive circuit DR. The upper controller EA is connected to the communication bus BS such that signals (detection values, calculation values, control flags, and the like) can be shared with the various controllers (EB, EG, ED, and the like).

The braking operation amount Ba and the rear wheel supply pressure Pv are input to the upper controller EA. The braking operation amount Ba is a generic term for a state quantity representing the operation amount of the braking operation member BP. The detection signal Sp (the operation displacement) of the operation displacement sensor SP and the detection signal Pz (the simulator pressure) of the simulator pressure sensor PZ are directly input to the upper controller EA as the braking operation amount Ba. The detection signal Pv (the rear wheel supply pressure) of the rear wheel supply pressure sensor PV is directly input to the upper controller EA.

The front wheel supply pressure Pm, a limit regenerative braking force Fx, the required deceleration Gs, and the like are input to the upper controller EA via the communication bus BS. The front wheel supply pressure Pm is detected by a supply pressure sensor PM provided in the lower actuator YB and transmitted from the lower controller EB. The “limit regenerative braking force Fx” is a maximum value (limit value) of the regenerative braking force Fg that can be generated by the regeneration device KG. The limit regenerative braking force Fx is calculated by the regeneration controller EG and transmitted from the regeneration controller EG. The required deceleration Gs is a target value of a vehicle deceleration in the automatic braking control. The required deceleration Gs is calculated by the driving assistance controller ED and transmitted from the driving assistance controller ED.

An algorithm for the pressure adjustment control is programmed in the upper controller EA (in particular, the microprocessor MP). The “pressure adjustment control” is a control for adjusting the front wheel and rear wheel supply pressures Pm, Pv (finally, the front wheel and rear wheel pressures Pwf, Pwr), and includes the regenerative coordination control. The pressure adjustment control is executed based on the braking operation amount Ba (the operation displacement Sp, the simulator pressure Pz), the required deceleration Gs, the front wheel and rear wheel supply pressures Pm, Pv, and the limit regenerative braking force Fx. Here, the braking operation amount Ba and the required deceleration Gs are generically referred to as a “braking required amount Bs”. That is, the braking required amount Bs is an input for instructing the wheel pressure Pw (result, the friction braking force Fm) to be generated by the braking control device SC.

Based on the algorithm of the pressure adjustment control, the electric motor MA and the various solenoid valves (UJ, UK, and the like) constituting the upper actuator YA are driven by the drive circuit DR. In the drive circuit DR, an H-bridge circuit is implemented by a switching element (for example, a MOS-FET) to drive the electric motor MA. The drive circuit DR includes a switching element to drive the various solenoid valves (UJ, UK, and the like). In addition, the drive circuit DR includes a motor current sensor (not shown) that detects a supply current Im (an actual value) to the electric motor MA, and upstream side and downstream side current sensors (not shown) that detect the supply currents Ij, Ik (which are actual values, and referred to as “upstream side and downstream side currents”) to the upstream side and downstream side pressure adjustment valves UJ, UK. The electric motor MA is provided with a rotation angle sensor (not shown) that detects a rotation angle Ka (an actual value) of a rotary element of the electric motor MA. Then, a motor rotation speed Na is calculated based on the motor rotation angle Ka.

In the upper controller EA, upstream side and downstream side target currents Itj, Itk, which are target values corresponding to the upstream side and downstream side currents Ij, Ik, are calculated based on the braking required amount Bs. Then, the upstream side and downstream side currents Ij, Ik (the actual values) are controlled to be close to and coincide with the upstream side and downstream side target currents Itj, Itk (the target values). In the upper controller EA, a target rotation speed Nta (a target value) corresponding to the actual rotation speed Na is calculated based on the braking required amount Bs. The motor supply current Im is controlled such that the actual rotation speed Na is close to and coincides with the target rotation speed Nta. Based on these control algorithms, a drive signal Ma for controlling the electric motor MA and drive signals Uj, Uk, Va, Vb for controlling the various solenoid valves UJ, UK, VA, VB are calculated. Then, according to the drive signals (Ma and the like), switching elements of the drive circuit DR are driven, and the electric motor MA and the solenoid valves UJ, UK, VA, VB are controlled.

### <Lower Braking Unit SB>

The lower braking unit SB is a general-purpose unit (device) for executing an antilock brake control, a traction control, an electronic stability control, and the like. In the antilock brake control, the traction control, the electronic stability control, and the like, the wheel pressure Pw of each wheel cylinder CW is independently adjusted, and thus these controls are also generically referred to as “each-wheel independent control”. In the lower braking unit SB, the wheel pressure Pw can be individually adjusted for each wheel cylinder CW so as to execute the each-wheel independent control.

The lower braking unit SB is provided between the upper braking unit SA and the wheel cylinders CW. The front wheel and rear wheel supply pressures Pm, Pv are supplied from the upper braking unit SA to the lower braking unit SB. Then, in the lower braking unit SB, the front wheel and rear wheel supply pressures Pm, Pv are adjusted (increased or decreased), and are output as the liquid pressures Pwf, Pwr (the front wheel and rear wheel pressures) of the front wheel and the rear wheel cylinders CWf, CWr. When the lower braking unit SB is not operating (at the time of non-execution of the each-wheel independent control), the front wheel and rear wheel pressures Pwf, Pwr are equal to the front wheel and rear wheel supply pressures Pm, Pv.

The front wheel supply pressure sensor PM is provided to detect the actual liquid pressure Pm (the front wheel supply pressure) supplied from the upper actuator YA (in particular, the master chamber Rm). The front wheel supply pressure sensor PM is also referred to as a “master pressure sensor”, and is built in the lower actuator YB. A signal of the front wheel supply pressure Pm is directly input to the lower controller EB and is output to the communication bus BS.

### <Processing of Pressure Adjustment Control>

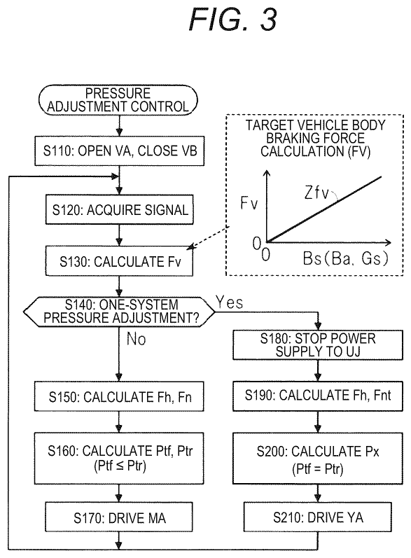

A processing example of the pressure adjustment control will be described with reference to a flowchart of FIG. 3. The pressure adjustment control is a control on the front wheel and rear wheel supply pressures Pm, Pv (result, the front wheel and rear wheel pressures Pwf, Pwr) based on the braking required amount Bs (Ba, Gs, and the like). In the pressure adjustment control, the two-system pressure adjustment is implemented by the upper braking unit SA. The “two-system pressure adjustment” is a pressure adjustment control in which the front wheel and rear wheel pressures Pwf, Pwr are independently and individually adjusted. On the contrary to the two-system pressure adjustment, a pressure adjustment control in which the front wheel and rear wheel pressures Pwf, Pwr are adjusted to be equal is referred to as the “one-system pressure adjustment”. In the regenerative coordination control, the two-system pressure adjustment improves a regeneration efficiency and makes the braking force distribution between the front and rear wheels appropriate compared to the one-system pressure adjustment. The algorithm of the pressure adjustment control is programmed in the microprocessor MP of the upper controller EA.

In the description of the processing example, the following is assumed.
The regeneration device KG is provided only in the front wheel WHf. Therefore, the regenerative braking force Fg acts on the front wheel WHf but does not act on the rear wheel WHr.
In the upper actuator YA, the pressure receiving area rm (also referred to as a “master area”) of the master chamber Rm and the pressure receiving area ru (also referred to as a “servo area”) of the servo chamber Ru are set to be equal. Therefore, “rm=ru” is satisfied, and in a static state, “Pk=Pm” is satisfied (here, the friction or the like of the seal member SL is ignored).
The front wheel supply pressure sensor PM is built in the lower braking unit SB, and the front wheel supply pressure Pm is input to the upper braking unit SA via the communication bus BS. On the other hand, the rear wheel supply pressure sensor PV is built in the upper braking unit SA, and the rear wheel supply pressure Pv is directly input to the upper braking unit SA.

Various braking forces are as follows.
A “vehicle body total braking force Fu” is an actual braking force that acts on the entire vehicle JV. A target value corresponding to the vehicle body total braking force Fu is a “target vehicle body braking force Fv”.
The “friction braking force Fm” is a braking force actually generated according to the wheel pressure Pw. A target value corresponding to the friction braking force Fm is a “target friction braking force Fn”.
The “regenerative braking force Fg” is a braking force actually generated by the regeneration device KG. A target value corresponding to the regenerative braking force Fg is a “target regenerative braking force Fh”. The target regenerative braking force Fh is calculated by the upper braking unit SA (in particular, the upper controller EA) or the lower braking unit SB (in particular, the lower controller EB), and is transmitted to the regeneration device KG (in particular, the regeneration controller EG) via the communication bus BS. In the regeneration device KG, the generator GN is controlled by the regeneration controller EG such that the actual regenerative braking force Fg is close to and coincides with the target regenerative braking force Fh.
The “limit regenerative braking force Fx” is the regenerative braking force Fg that can be generated by the regeneration device KG. In other words, the limit regenerative braking force Fx is the maximum value (limit value) of the regenerative braking force Fg that can be generated by the regeneration device KG. Therefore, in the regeneration device KG, the regenerative braking force Fg is generated within a range (limit) to the limit regenerative braking force Fx. The limit regenerative braking force Fx is calculated by the regeneration device KG (in particular, the regeneration controller EG), and is transmitted to the upper braking unit SA (in particular, the upper controller EA) via the communication bus BS.

In step S110, the power supply to the introduction valve VA and the release valve VB is performed. Accordingly, the normally closed type introduction valve VA is opened, the normally open type release valve VB is closed, and the first mode in which the master piston NM and the braking operation member BP can be separately displaced is selected. In the first mode, the front wheel and rear wheel supply pressures Pm, Pv (that is, the front wheel and rear wheel pressures Pwf, Pwr) are adjusted independently of the operation of the braking operation member BP. In this case, the operation force Fp of the braking operation member BP is generated by the stroke simulator SS.

In step S120, various signals (Ba and the like) are read. The braking operation amount Ba (Sp, Pz, and the like) is detected by the braking operation amount sensor BA (SP, PZ, and the like) and input to the upper controller EA. The rear wheel supply pressure Pv is detected by the rear wheel supply pressure sensor PV and input to the upper controller EA. The required deceleration Gs is acquired from the driving assistance controller ED via the communication bus BS. The front wheel supply pressure Pm is acquired from the lower controller EB via the communication bus BS. The limit regenerative braking force Fx is acquired from the regeneration controller EG via the communication bus BS.

In step S130, the braking required amount Bs is calculated based on the braking operation amount Ba and the required deceleration Gs. For example, the braking operation amount Ba and the required deceleration Gs are compared in the dimension of the vehicle deceleration, and the larger one is determined as the braking required amount Bs. The braking required amount Bs is an instruction value for the supply pressures Pm, Pv (=Pw) required for the braking control device SC. Furthermore, in step S130, the target vehicle body braking force Fv (the target value of the braking force on the entire vehicle) is calculated based on the braking required amount Bs and a calculation map Zfv. The target vehicle body braking force Fv is calculated to increase as the braking required amount Bs increases in accordance with the calculation map Zfv. That is, the target vehicle body braking force Fv is determined to increase as the braking required amount Bs increases.

In step S140, it is determined whether to execute the “one-system pressure adjustment”. This determination is referred to as a “switching determination”. In the pressure adjustment control, the two-system pressure adjustment is selected as the initial control. For example, in the lower braking unit SB, based on the start of the execution of the antilock brake control (control for preventing the lock of the wheel WH on the basis of the wheel speed Vw and the vehicle body speed Vx), the switching determination is positive, and the pressure adjustment control is switched from the two-system pressure adjustment to the one-system pressure adjustment. Here, the presence or absence of the execution of the antilock brake control (the ABS control) is transmitted from the lower controller EB by a control flag FA (also referred to as an “execution flag”). In the execution flag FA, “O” indicates that “the ABS control is not executed”, and “1” indicates “the ABS control is being executed”. Therefore, the switching determination is positive at a time point (a corresponding calculation cycle) when the execution flag FA is switched from 0 (non-execution)” to “1 (execution)”.

The switching determination may be determined based on the operation state of the regeneration device KG. Specifically, when the regenerative braking force Fg generated by the regeneration device KG is not generated, the switching determination is positive. An example includes a case where the storage battery BG is fully charged and the regeneration device KG is no longer able to generate the regenerative braking force Fg, or a case where some kind of failure occurs in the regeneration device KG. Operation information of the regeneration device KG is transmitted to the upper controller EA when the limit regenerative braking force Fx (that is, the generatable regenerative braking force) is “0”.

If the switching determination in step S140 is negative, the processing proceeds to step S150, and the two-system pressure adjustment (processing in steps S150 to S170) is executed. On the other hand, if the switching determination is positive, the processing proceeds to step S180, and the one-system pressure adjustment (processing in steps S180 to S210) is executed.

### <<Processing of Two-System Pressure Adjustment>>

In step S150, front wheel and rear wheel required braking forces Fqf, Fqr (=Fq) are calculated based on the target vehicle body braking force Fv. Specifically, the front wheel and rear wheel required braking forces Fqf, Fqr are calculated such that the following two conditions are satisfied. The “front wheel required braking force Fqf” is a target value of the entire braking force acting on the front wheel WHf. Therefore, the front wheel required braking force Fqf coincides with a sum of the target regenerative braking force Fh and a front wheel target friction braking force Fnf (that is, “Fqf=Fh+Fnf”). The “rear wheel required braking force Fqr” is a target value of the entire braking force acting on the rear wheel WHr. Therefore, the rear wheel required braking force Fqr coincides with a rear wheel target friction braking force Fnr (that is, “Fqr=Fnf”).

Condition 1: the sum of the front wheel required braking force Fqf and the rear wheel required braking force Far coincides with the target vehicle body braking force Fv (that is, Fv=Fqf+Fqr”).

Condition 2: a ratio of the rear wheel required braking force Fqr to the front wheel required braking force Fqf coincides with a predetermined value hb (that is, “Far/Fqf=hb”). Here, the predetermined value hb is a ratio of a rear wheel friction braking force Fmr to a front wheel friction braking force Fmf when the regenerative braking force Fg is “0”. Therefore, the predetermined value hb is a constant set in advance based on specifications of the braking device SX.

The front wheel and rear wheel required braking forces Fqf, Fqr are determined by the following Expression (1) so as to satisfy Conditions 1 and 2.

$$Fqf = Fv / ( 1 + hb ) \qquad Expression ( 1 )$$

$$and$$

$$Fqr = Fv \cdot hb / ( 1 + hb )$$

Furthermore, in step S150, the target regenerative braking force Fh and the front wheel and rear wheel target friction braking forces Fnf, Fnr are calculated based on the front wheel and rear wheel required braking forces Fqf, Fqr and the limit regenerative braking force Fx. Specifically, the target regenerative braking force Fh is determined to be equal to or less than the limit regenerative braking force Fx. For example, if the front wheel required braking force Fqf is equal to or less than the limit regenerative braking force Fx, the target regenerative braking force Fh is made equal to the front wheel required braking force Fqf, the front wheel target friction braking force Fnf is set to “0”, and the rear wheel friction braking force Fnr is made equal to the rear wheel required braking force Fqr (that is, if “Fqf≤Fx”, “Fh=Fqf, Fnf=0, Fnr=Fqr”). On the other hand, if the front wheel required braking force Fqf is larger than the limit regenerative braking force Fx, the target regenerative braking force Fh is made equal to the limit regenerative braking force Fx, the front wheel target friction braking force Fnf is set to a “value obtained by subtracting the limit regenerative braking force Fx (=Fh) from the front wheel required braking force Fqf”, and the rear wheel friction braking force Fnr is made equal to the rear wheel required braking force Fqr (that is, if “Fqf>Fx”, “Fh=Fx, Fnf=Fqf−Fx=Fqf−Fh, Fnr=Fqr”).

In step S160, front wheel and rear wheel target pressures Ptf, Ptr are calculated based on the front wheel and rear wheel target friction braking forces Enf, Fnr (=Fn). The front wheel and rear wheel target pressures Ptf, Ptr are determined by converting the target friction braking force Fn into dimensions of the front wheel and rear wheel supply pressures Pm, Pv (that is, the front wheel and rear wheel pressures Pwf, Pwr) based on the specifications of the braking device SX and the like (the pressure receiving area of the wheel cylinder CW, an effective braking radius of the rotating member KT, a friction coefficient of the friction member MS, an effective radius of the wheel (tire), and the like). That is, the front wheel and rear wheel target pressures Ptf, Ptr are calculated based on the braking required amount Bs and the limit regenerative braking force Fx (the regenerative braking force that can be generated by the regeneration device KG). The front wheel supply pressure Pm is equal to the front wheel pressure Pwf, and the rear wheel supply pressure Pv is equal to the rear wheel pressure Pwr, and thus the front wheel and rear wheel target pressures Ptf, Ptr are also target values for the front wheel and rear wheel pressures Pwf, Pwr.

In step S170, the front wheel and rear wheel pressures Pwf, Pwr (the actual values) are adjusted based on the front wheel and rear wheel target pressures Ptf, Ptr (the target values). The upper controller EA performs the control to drive the electric motor MA and the upstream side and downstream side pressure adjustment valves UJ, UK, and to cause the front wheel and rear wheel pressures Pwf, Pwr to be close to and coincide with the front wheel and rear wheel target pressures Ptf, Ptr. Specifically, in step S170, the electric motor MA is driven, and the circulation flow KN including the fluid pump QA and the upstream side and downstream side pressure adjustment valves UJ, UK is generated. Then, the downstream side pressure adjustment valve UK is subjected to a liquid pressure feedback control based on the front wheel target pressure Ptf and the front wheel supply pressure Pm such that the front wheel supply pressure Pm (=Pwf) coincides with the front wheel target pressure Ptf. That is, the supply current Ik (which is an actual value and also referred to as the “downstream side current”) to the downstream side pressure adjustment valve UK is adjusted such that a deviation hPf (referred to as a “front wheel deviation”) between the front wheel supply pressure Pm and the front wheel target pressure Ptf becomes “0”. The upstream side pressure adjustment valve UJ is subjected to a liquid pressure feedback control based on the rear wheel target pressure Ptr and the rear wheel supply pressure Pv such that the rear wheel supply pressure Pv (=Pwr) coincides with the rear wheel target pressure Ptr. That is, the supply current Ij (which is an actual value and also referred to as the “upstream side current”) to the upstream side pressure adjustment valve UJ is adjusted such that a deviation hPr (referred to as a “rear wheel deviation”) between the rear wheel supply pressure Pv and the rear wheel target pressure Ptr becomes “0”.

### <<Processing of One-System Pressure Adjustment>>

If the switching determination in step S140 is positive, in step S180, the power supply to the upstream side pressure adjustment valve UJ is stopped, and the upstream side pressure adjustment valve UJ is opened. Since the upstream side pressure adjustment valve UJ is a normally open solenoid valve, the upstream side pressure adjustment valve UJ is brought into a fully open state when the power supply is stopped. Accordingly, switching from the two-system pressure adjustment to the one-system pressure adjustment is performed. Switching the two-system pressure adjustment to the one-system pressure adjustment is referred to as “pressure adjustment switching”.

In step S190, a sum Ent (also referred to as a “target sum”) of the target regenerative braking force Fh and the target friction braking force Fn is calculated based on the target vehicle body braking force Fv and the limit regenerative braking force Fx. Here, the “target sum Ent” is a sum of the front wheel target friction braking force Fnf and the rear wheel target friction braking force Fnr (that is, “Fnt=Fnf+Fnr”). In step S190, similar to the processing of step S150, the target regenerative braking force Fh is determined as a value equal to or less than the limit regenerative braking force Fx. For example, if the target vehicle body braking force Fv is equal to or less than the limit regenerative braking force Fx, the target regenerative braking force Fh is made equal to the target vehicle body braking force Fv, and the sum Ent of the target friction braking forces Fn is set to “0” (that is, if “Fv≤Fx”, “Fh=Fv, Fnt=0”). If the target vehicle body braking force Fv is larger than the limit regenerative braking force Fx, the target regenerative braking force Fh is made equal to the limit regenerative braking force Fx, and the target sum Ent is set to a “value obtained by subtracting the target regenerative braking force Fh (=Fx) from the target vehicle body braking force Fv” (that is, if “Fv>Fx”, “Fh=Fx, Ent=Fv−Fh=Fv−Fx”). The target regenerative braking force Fh is transmitted to the communication bus BS.

In step S200, a common target pressure Px is calculated based on the target sum Fnt. Specifically, the common target pressure Px is determined by further adding a predetermined pressure ps after two conditions including the target sum Fnt and “Ptf=Ptr” are satisfied. Here, the predetermined pressure ps is a value corresponding to the sliding resistance of the seal member SL and is a preset predetermined value (constant). Note that, also in the common target pressure Px, liquid pressure conversion of the target sum Ent is performed based on the specifications of the braking device SX and the like (the pressure receiving area of the wheel cylinder CW, the effective braking radius of the rotating member KT, the friction coefficient of the friction member MS, the effective radius of the wheel (tire), and the like).

The “common target pressure Px” is a common target value unified in the braking system related to the front and rear wheels corresponding to the front wheel and rear wheel supply pressures Pm, Pv. If “Fv≤Fx”, the common target pressure Px (=Ptf=Ptr) is determined to be “0”. If “Fv>Fx”, the common target pressure Px is calculated under the condition “Ptf=Ptr” such that the sum Ent (the target sum) of the target friction braking forces Fn corresponding to the common target pressures Px is made equal to the value “Fv−Fh”, and is determined by further adding the predetermined pressure ps.

In step S200, when the one-system pressure adjustment is performed, the actual regenerative braking force Fg may be set to “0”. This is achieved by setting the regenerative braking force Fx (the limit regenerative braking force) that can be generated by the regeneration device KG, or the target regenerative braking force Fh to “0”. If the switching determination is positive in the upper braking unit SA, the regenerative coordination control is ended, and the operation of the regeneration device KG can be stopped. If “Fg=0 (Fx=0 or Fh=0)”, similarly to the above, the common target pressure Px is determined by adding the predetermined pressure ps after “Ptf=Ptr, Enf+Fnr=Fv” is satisfied based on the specifications of the braking device SX and the like.

In step S210, the upper actuator YA is driven based on the common target pressure Px and the rear wheel supply pressure Pv. In the pressure adjustment unit CA, the upstream side servo pressure Pj and the downstream side servo pressure Pk are made equal while the upstream side pressure adjustment valve UJ is in the fully open state. That is, since a state of “Pk=Pm=Pwf=Pj=Pv=Pwr” is satisfied, the downstream side pressure adjustment valve UK is subjected to the liquid pressure feedback control such that the rear wheel supply pressure Pv is close to and coincides with the common target pressure Px. Specifically, the supply current Ik (the downstream side current) to the downstream side pressure adjustment valve UK is adjusted such that a deviation hPx (referred to as a “common deviation”) between the rear wheel supply pressure Pv and the common target pressure Px becomes “0”.

The braking control device SC is a brake-by-wire device capable of independently controlling the operation of the braking operation member BP (the brake pedal) and the liquid pressure (the wheel pressure Pw) of the wheel cylinder CW. The upper braking unit SA is provided with the master chamber Rm (the supply chamber) and the servo chamber Ru. The master chamber Rm and the servo chamber Ru are sealed by the seal member SL, and then are partitioned by the master cylinder CM and the master piston NM. In the upper braking unit SA (in particular, the pressure adjustment unit CA), the upstream side and downstream side servo pressures Pj, Pk are electrically and individually adjusted by the two linear solenoid valves UJ, UK (the upstream side and downstream side pressure adjustment valves).

In the two-system pressure adjustment, the front wheel pressure Pwf is adjusted by the downstream side servo pressure Pk based on the braking required amount Bs and the front wheel supply pressure Pm. The downstream side servo pressure Pk is supplied to the servo chamber Ru, so that the front wheel supply pressure Pm is output from the master chamber Rm, and finally the front wheel pressure Pwf is adjusted. That is, the downstream side servo pressure Pk is transmitted as the front wheel supply pressure Pm (finally, the front wheel pressure Pwf) via the master cylinder CM and the master piston NM. On the other hand, the rear wheel pressure Pwr is adjusted by the upstream side servo pressure Pj based on the braking required amount Bs and the rear wheel supply pressure Pv. The upstream side servo pressure Pj is directly supplied as the rear wheel supply pressure Pv (finally, the rear wheel pressure Pwr) from the pressure adjustment unit CA to the rear wheel cylinder CWr without passing through the master cylinder CM and the master piston NM. The upstream side and downstream side pressure adjustment valves UJ, UK are subjected to a feedback control such that the front wheel and rear wheel supply pressures Pm, Pv are close to and coincide with the front wheel and rear wheel target pressures Ptf, Ptr calculated based on the braking required amount Bs.

If the two-system pressure adjustment is switched to the one-system pressure adjustment (that is, if the pressure adjustment switching is performed), the power supply to the upstream side pressure adjustment valve UJ is stopped, and a state is made in which the upstream side servo pressure Pj and the downstream side servo pressure Pk are made equal. That is, the individual adjustment of the front wheel supply pressure Pm and the rear wheel supply pressure Pv is eliminated. In the one-system pressure adjustment, the target values corresponding to the front wheel and rear wheel supply pressures Pm, Pv are determined as the same target values Px (common target pressures) in the front and rear wheel systems. Here, the predetermined pressure ps is added to the common target pressure Px in consideration of an influence of the sliding resistance of the seal member SL. Based on the common target pressure Px and the rear wheel supply pressure Pv, the front wheel and rear wheel pressures Pwf, Pwr are adjusted by the downstream side servo pressure Pk. The downstream side pressure adjustment valve UK is subjected to the feedback control such that the rear wheel supply pressure Pv is close to and coincides with the common target pressure Px.

A signal of the supply pressure related to the one-system pressure adjustment has a choice of the front wheel supply pressure Pm or the rear wheel supply pressure Pv. The sliding resistance of the seal member SL may act as a disturbance, and the front wheel supply pressure Pm includes the sliding resistance, whereas the rear wheel supply pressure Pv does not include the sliding resistance. The front wheel supply pressure Pm is acquired through the communication bus BS, and thus a communication delay is included, but the rear wheel supply pressure Pv is directly input to the upper controller EA, and is therefore not affected by the communication delay. When the communication bus BS is abnormal, the front wheel supply pressure Pm cannot be acquired, but the rear wheel supply pressure Pv can be acquired. Therefore, in the braking control device SC, the rear wheel supply pressure Pv is used for the one-system pressure adjustment.

When the rear wheel supply pressure Pv is adopted, if the two-system pressure adjustment is switched to the one-system pressure adjustment (that is, at the time of the pressure adjustment switching), the control on the front wheel pressure Pwf transitions from one that includes the sliding resistance (that is, the control by the front wheel supply pressure Pm) to one that does not include the sliding resistance (that is, the control by the rear wheel supply pressure Pv). Therefore, a discontinuity (result, a change in the liquid pressure) of the front wheel pressure Pwf is generated at the time of the pressure adjustment switching. Specifically, the rear wheel supply pressure Pv does not include the friction resistance of the seal member SL, and thus, at the time of the pressure adjustment switching, the front wheel pressure Pwf is reduced by an amount of the friction resistance.

In the braking control device SC, the predetermined pressure ps is added to the common target pressure Px so as to compensate for a liquid pressure component due to the friction of the seal member SL. Accordingly, a change in the wheel pressure Pw (in particular, a decrease in the front wheel pressure Pwf due to the sliding friction resistance) in the case where the two-system pressure adjustment is switched to the one-system pressure adjustment is prevented, and the smooth pressure adjustment switching is achieved. The rear wheel pressure Pwr is increased by an amount of the predetermined pressure ps at the time of the pressure adjustment switching, but since an influence of the front wheel braking force is dominant in the braking force of the entire vehicle, an influence of a change in the rear wheel braking force on vehicle deceleration is slight.

The switching from the two-system pressure adjustment to the one-system pressure adjustment is performed when the antilock brake control is executed in the lower braking unit SB. Alternatively, this switching is performed when the regeneration device KG cannot generate the regenerative braking force Fg. For example, this is a case where the storage battery BG of the regeneration device KG is fully charged. Since the state of charge of the storage battery BG is monitored normally, when the storage battery BG is closely fully charged, the switching from the two-system pressure adjustment to the one-system pressure adjustment may be completed before the start of the braking operation (that is, at the time of non-braking in the state of “Bs=0”). Accordingly, since a change in the wheel pressure Pw does not occur during the braking operation, the driver is less likely to feel any discomfort. On the other hand, the execution of the antilock brake control is performed during the braking operation, and thus the driver can easily feel any discomfort. Therefore, the resistance compensation of the seal member SL based on the addition of the predetermined pressure ps is particularly effective at the time of the execution of the antilock brake control started during braking.

### <Drive Control of Two-System Pressure Adjustment>

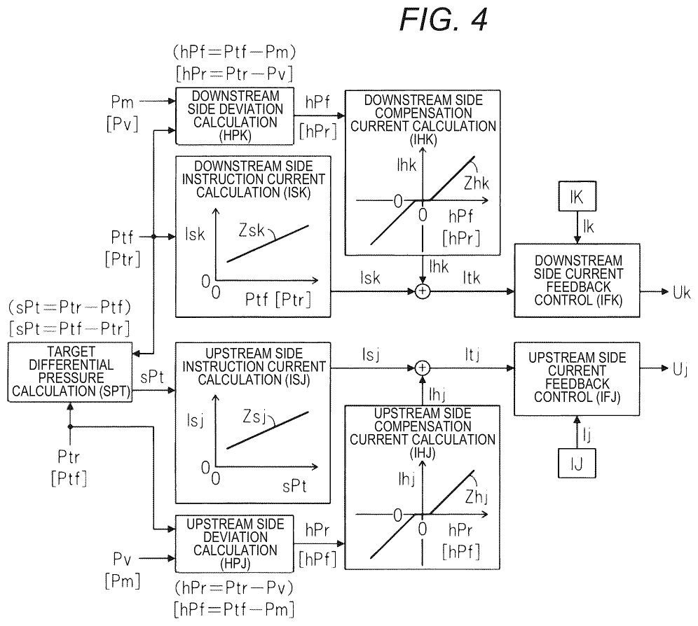

A detailed description of a drive control example of the two-system pressure adjustment (in particular, the processing of step S170) will be given with reference to a block diagram of FIG. 4. The control processing is executed by the upper controller EA. In the two-system pressure adjustment, the electric motor MA is driven, and the circulation flow KN of the braking liquid BF including the upstream side and downstream side pressure adjustment valves UJ, UK and the fluid pump QA is generated.

### <<Drive Control of Downstream Side Pressure Adjustment Valve UK>>

The drive control of the downstream side pressure adjustment valve UK will be described. Drive processing according to the downstream side pressure adjustment valve UK includes a downstream side instruction current calculation block ISK, a downstream side deviation calculation block HPK, a downstream side compensation current calculation block IHK, and a downstream side current feedback control block IFK.

In the downstream side instruction current calculation block ISK, a downstream side instruction current Isk is calculated based on the front wheel target pressure Ptf and a preset calculation map Zsk. The “downstream side instruction current Isk” is a target value related to the supply current Ik (the downstream side current) of the downstream side pressure adjustment valve UK, which is necessary to achieve the front wheel target pressure Ptf. In accordance with the calculation map Zsk, the downstream side instruction current Isk is determined to increase according to an increase in the front wheel target pressure Ptf. The downstream side instruction current calculation block ISK corresponds to a feedforward control based on the front wheel target pressure Ptf.

In the downstream side deviation calculation block HPK, the deviation hPf (the front wheel deviation) between the front wheel target pressure Ptf and the front wheel supply pressure Pm (that is, the wheel pressure Pwf) is calculated. Specifically, the front wheel supply pressure Pm is subtracted from the front wheel target pressure Ptf to calculate the front wheel deviation hPf (that is, “hPf=Ptf−Pm”).

In the downstream side compensation current calculation block IHK, a downstream side compensation current Ihk is calculated based on the front wheel deviation hPf and a preset calculation map Zhk. The downstream side instruction current Isk is calculated corresponding to the front wheel target pressure Ptf, and an error may occur between the front wheel target pressure Ptf and the front wheel supply pressure Pm. The “downstream side compensation current Ihk” is for compensating (decreasing) the error and causing the front wheel supply pressure Pm to coincide with the front wheel target pressure Ptf. The downstream side compensation current Ihk is determined to increase according to an increase in the front wheel deviation hPf in accordance with the calculation map Zhk. Specifically, if the front wheel target pressure Ptf is larger than the front wheel supply pressure Pm and the front wheel deviation hPf has a positive sign, the downstream side compensation current Ihk with the positive sign is determined such that the downstream side instruction current Isk is increased. On the other hand, if the front wheel target pressure Ptf is smaller than the front wheel supply pressure Pm, and the front wheel deviation hPf has a negative sign, the downstream side compensation current Ihk with the negative sign is determined such that the downstream side instruction current Isk is decreased. Here, a dead zone is provided in the calculation map Zhk. The downstream side compensation current calculation block IHK corresponds to the feedback control based on the front wheel supply pressure Pm.

The downstream side compensation current Ihk is added to the downstream side instruction current Isk to calculate the downstream side target current Itk (that is, “Itk=Isk+Ihk”). The “downstream side target current Itk” is a final target value of the current supplied to the downstream side pressure adjustment valve UK. Therefore, the drive control of the downstream side pressure adjustment valve UK is implemented by the feedforward control and the feedback control.

In the downstream side current feedback control block IFK, the downstream side drive signal Uk is calculated based on the downstream side target current Itk (the target value) and the downstream side current Ik (the actual value) such that the downstream side current Ik is close to and coincides with the downstream side target current Itk. Here, the downstream side current Ik is detected by a downstream side current sensor IK provided in the drive circuit DR. In the downstream side current feedback control block IFK, if “Itk>Ik”, the drive signal Uk is determined such that the downstream side current Ik increases. On the other hand, if “Itk<Ik”, the drive signal Uk is determined such that the downstream side current Ik decreases. That is, in the downstream side current feedback control block IFK, the feedback control related to the current is executed. Therefore, in the drive control of the downstream side pressure adjustment valve UK, in addition to the feedback control related to the liquid pressure, the feedback control related to the current is provided, and the downstream side servo pressure Pk (=Pm=Pwf) is controlled to coincide with the front wheel target pressure Ptf.

### <<Drive Control of Upstream Side Pressure Adjustment Valve UJ>>

The drive control of the upstream side pressure adjustment valve UJ will be described. The downstream side pressure adjustment valve UK is controlled based on the front wheel target pressure Ptf, but the upstream side pressure adjustment valve UJ is controlled based on a difference sPt between the front wheel target pressure Ptf and the rear wheel target pressure Ptr. In addition, the upstream side pressure adjustment valve UJ is controlled based on the feedback control related to the rear wheel supply pressure Pv. Since other configurations are the same as those of the downstream side pressure adjustment valve UK, a common portion will be briefly described. Drive processing related to the upstream side pressure adjustment valve UJ includes a target differential pressure calculation block SPT, an upstream side instruction current calculation block ISJ, an upstream side deviation calculation block HPJ, an upstream side compensation current calculation block IHJ, and an upstream side current feedback control block IFJ.

In the target differential pressure calculation block SPT, the target differential pressure sPt is calculated based on the front wheel and rear wheel target pressures Ptf, Ptr. The “target differential pressure sPt” is a target value of the differential pressure (a difference between the upstream side liquid pressure and the downstream side liquid pressure with respect to the upstream side pressure adjustment valve UJ) to be generated by the upstream side pressure adjustment valve UJ. Specifically, the target differential pressure sPt is determined by subtracting the front wheel target pressure Ptf from the rear wheel target pressure Ptr (that is, “sPt=Ptr−Ptf (≥0)”). The upstream side pressure adjustment valve UJ increases an amount corresponding to the target differential pressure sPt from the downstream side servo pressure Pk (=Pm) to generate the upstream side servo pressure Pj (=Pv).

In the upstream side instruction current calculation block ISJ, an upstream side instruction current Isj is calculated based on the target differential pressure sPt and a preset calculation map Zsj. The “upstream side instruction current Isj” is a target value related to the supply current Ij (the upstream side current) of the upstream side pressure adjustment valve UJ, which is required to achieve the target differential pressure sPt. In accordance with the calculation map Zsj, the upstream side instruction current Isj is determined to increase according to an increase in the target differential pressure sPt. The upstream side instruction current calculation block ISJ corresponds to a feedforward control based on the target differential pressure sPt.

In the upstream side deviation calculation block HPJ, the deviation hPr (the rear wheel deviation) between the rear wheel target pressure Ptr and the rear wheel supply pressure Pv (that is, the rear wheel pressure Pwr) is calculated. Specifically, the rear wheel supply pressure Pv is subtracted from the rear wheel target pressure Ptr to calculate the rear wheel deviation hPr (that is, “hPr=Ptr−Pv”).

In the upstream side compensation current calculation block IHJ, an upstream side compensation current Ihj is calculated based on the rear wheel deviation hPr and a preset calculation map Zhj. The “upstream side compensation current Ihj” is for compensating (decreasing) the error between the rear wheel target pressure Ptr and the rear wheel supply pressure Pv and causing the rear wheel supply pressure Pv to coincide with the rear wheel target pressure Ptr. The upstream side compensation current Ihj is determined to increase according to an increase in the rear wheel deviation hPr in accordance with the calculation map Zhj. The upstream side compensation current calculation block IHJ corresponds to the feedback control based on the rear wheel supply pressure Pv.

The upstream side compensation current Ihj is added to the upstream side instruction current Isj to calculate the upstream side target current Itj (that is, “Itj=Isj+Ihj”). The “upstream side target current Itj” is a final target value of the current supplied to the upstream side pressure adjustment valve UJ. Therefore, the drive control of the upstream side pressure adjustment valve UJ is implemented by the feedforward control and the feedback control.

In the upstream side current feedback control block IFJ, the upstream side drive signal Uj is calculated based on the upstream side target current Itj (the target value) and the upstream side current Ij (the actual value) such that the upstream side current Ij is close to and coincides with the upstream side target current Itj. Here, the upstream side current Ij is detected by an upstream side current sensor IJ provided in the drive circuit DR. In the upstream side current feedback control block IFJ, the feedback control related to the current is executed. Therefore, in the drive control of the upstream side pressure adjustment valve UJ, in addition to the feedback control related to the liquid pressure, the feedback control related to the current is provided, and the upstream side servo pressure Pj (=Pv=Pwr) is controlled to coincide with the rear wheel target pressure Ptr.

### <Drive Control of One-System Pressure Adjustment>

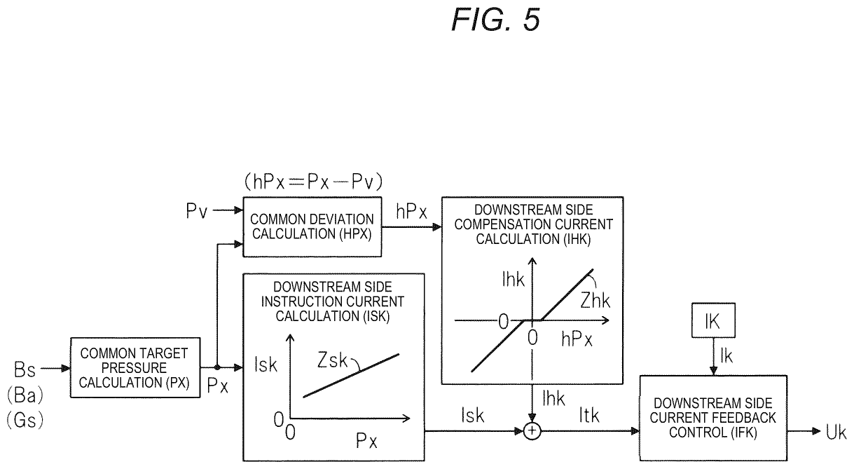

A detailed description of a drive control example of the one-system pressure adjustment (in particular, the processing of step S210) will be given with reference to a block diagram of FIG. 5. The control processing is also executed by the upper controller EA in the same manner as the two-system pressure adjustment. In the one-system pressure adjustment, the electric motor MA is driven, and the circulation flow KN of the braking liquid BF including the upstream side and downstream side pressure adjustment valves UJ, UK and the fluid pump QA is generated. Here, the upstream side pressure adjustment valve UJ is in a non-energization state and is in a fully open state. Since the processing (ISK, IHK, IFK) denoted by the same symbols as that of the two-system pressure adjustment is the same as the processing described above, the detailed description thereof will be omitted.

In a common target pressure calculation block PX, the common target pressure Px is calculated based on the braking required amount Bs. The braking required amount Bs is a generic term for the braking operation amount Ba and the required deceleration Gs, and is a required value for the wheel pressure Pw. The common target pressure Px is calculated by making the front wheel and rear wheel target pressures Ptf, Ptr equal and then adding the predetermined pressure ps. That is, the common target pressure Px is a unified target value for the front wheel and rear wheel supply pressures Pm, Pv.

In a common deviation calculation block HPX, the common deviation hPx is calculated based on the common target pressure Px and the rear wheel supply pressure Pv. Specifically, the rear wheel supply pressure Pv is subtracted from the common target pressure Px to determine the common deviation hPx (that is, “hPx=Px−Pv”).

In the downstream side instruction current calculation block ISK, the downstream side instruction current Isk is calculated based on the common target pressure Px and the calculation map Zsk. In the downstream side compensation current calculation block IHK, the downstream side compensation current Ihk is calculated based on the common deviation hPx and the calculation map Zhk. Similarly to the two-system pressure adjustment, in the one-system pressure adjustment, the downstream side compensation current Ihk is also added to the downstream side instruction current Isk to determine the downstream side target current Itk. Then, in the downstream side current feedback control block IFK, the drive signal Uk of the downstream side pressure adjustment valve UK is determined based on the downstream side target current Itk.

In the one-system pressure adjustment, functions of the blocks (that is, SPT, ISJ, HPJ, IHJ, and IFJ) related to the upstream side pressure adjustment valve UJ are stopped, and the energization to the upstream side pressure adjustment valve UJ is stopped (that is, “Ij=0”). In the blocks (in particular, ISK and HPK) related to the downstream side pressure adjustment valve UK, the common target pressure Px is employed instead of the front wheel target pressure Ptf, and the rear wheel supply pressure Pv is employed instead of the front wheel supply pressure Pm.

### <Application to Vehicle JV Including Regeneration Device KG in Rear Wheel WHr>

In the embodiment described above, a vehicle (referred to as a “front wheel regeneration vehicle”) is assumed in which the regeneration device KG is provided on the front wheel WHf but not on the rear wheels WHr. Alternatively, the braking control device SC may be applied to a vehicle (referred to as a “rear wheel regeneration vehicle”) in which the regeneration device KG is provided on the rear wheel WHr but not on the front wheel WHf. A difference will be described below. The symbols in [ ] in the block diagram of FIG. 4 correspond to the braking control device SC for the rear wheel regeneration vehicle.

In the braking control device SC applied to the rear wheel regeneration vehicle, in the schematic diagram of FIG. 2, the servo passage HV is connected to the reflux passage HK at the portion pj, and the rear wheel communication passage HSr is connected to the reflux passage HK at the portion pk. That is, the upstream side servo pressure Pj is supplied to the servo chamber Ru, and the downstream side servo pressure Pk is supplied to the rear wheel cylinder CWr (that is, “Pj=Pm=Pwf, Pk=Pv=Pwr”). In the processing of the pressure adjustment control (in particular, the two-system pressure adjustment) in FIG. 4 and FIG. 5, in the calculation of the front wheel and rear wheel target friction braking forces Fnf, Fnr, if “Fqr≤Fx”, “Fh=Fqr, Fnf=Fqf, Fnr=0” is determined. On the other hand, if “Fqf>Fx”, “Fh=Fx, Fnf=Fqf, Fnr=Fqr−Fx=Fqr−Fh” is determined. Then, the front wheel and rear wheel target friction braking forces Fnf, Fnr are converted into the front wheel and rear wheel target pressures Ptf, Ptr (here, “Ptf≥Ptr”).

Furthermore, in the block diagram of FIG. 4, the rear wheel target pressure Ptr is input to the downstream side instruction current calculation block ISK and the downstream side deviation calculation block HPK instead of the front wheel target pressure Ptf. That is, the downstream side instruction current Isk is determined based on the rear wheel target pressure Ptr and the calculation map Zsk, and in the downstream side deviation calculation block HPK, the rear wheel deviation hPr is calculated as “hPr=Ptr−Pv”. Then, in the downstream side compensation current calculation block IHK, the downstream side compensation current Ihk is calculated based on the rear wheel deviation hPr. In the target deviation calculation block SPT, the target differential pressure sPt is calculated as “sPt=Ptf−Ptr (≥0)”. The upstream side deviation calculation block HPJ receives the front wheel target pressure Ptf instead of the rear wheel target pressure Ptr. Therefore, in the upstream side deviation calculation block HPJ, the front wheel deviation hPf is calculated as “hPf=Ptf−Pm”. Then, in the upstream side compensation current calculation block IHJ, the upstream side compensation current Ihj is calculated based on the front wheel deviation hPf. Note that the processing of the one-system pressure adjustment is the same between the front wheel and rear wheel regeneration vehicles.

In a vehicle in which the regeneration device KG (=KGf, KGr) is provided in both of the front and rear wheels WHf and WHr, any one of the two configurations described above is employed depending on magnitude of a regeneration amount. Specifically, the braking control device SC of the front wheel regeneration vehicle is applied to a vehicle in which a regeneration amount of the front wheel regeneration device KGf is larger than a regeneration amount of the rear wheel regeneration device KGr. Conversely, the braking control device SC of the rear wheel regeneration vehicle is applied to a vehicle in which the regeneration amount of the front wheel regeneration device KGf is smaller than the regeneration amount of the rear wheel regeneration device KGf.

The pressure adjustment unit CA of the braking control device SC applied to the front wheel and rear wheel regeneration vehicles will be summarized. In the pressure adjustment unit CA, the normally open type upstream side and downstream side pressure adjustment valves UJ, UK are arranged in series in the circulation flow KN of the braking liquid BF including the fluid pump QA. A pressure of the braking liquid BF discharged from the fluid pump QA is adjusted to the upstream side and downstream side servo pressures Pj, Pk by the upstream side and downstream side pressure adjustment valves UJ, UK. In the two-system pressure adjustment, one (referred to as a “first servo pressure P1”) of the upstream side and downstream side servo pressures Pj, Pk is supplied to the servo chamber Ru, so that the front wheel supply pressure Pm is output from the supply chamber Rm to the front wheel cylinder CWf. That is, the front wheel supply pressure Pm is adjusted by the first servo pressure P1, and the front wheel pressure Pwf is adjusted by the front wheel supply pressure Pm (the liquid pressure transmission is in an order of “P1→Pm→Pwf”). The other (referred to as a “second servo pressure P2”) of the upstream side and downstream side servo pressures, Pj, Pk is output to the rear wheel cylinder CWr as the rear wheel supply pressure Pv. That is, the rear wheel supply pressure Pv is adjusted by the second servo pressure P2, and the rear wheel pressure Pwr is adjusted by the rear wheel supply pressure Pv (the liquid pressure transmission is in an order of “P2→Pv→Pwr”).

In the two-system pressure adjustment, the first and second servo pressures P1, P2 are individually adjusted, but in the one-system pressure adjustment, the first and second servo pressures P1, P2 are adjusted to be the same. That is, the front wheel and rear wheel supply pressures Pm, Pv are adjusted to be equal to each other by the first servo pressure P1 equal to the second servo pressure P2. The front wheel and rear wheel pressures Pwf, Pwr are adjusted to be equal according to the front wheel and rear wheel supply pressures Pm, Pv. The liquid pressure transmission is in the order of “(P1=P2)→(Pm=Pv)→(Pwf=Pwr)”. However, the front wheel supply pressure Pm includes the friction resistance, and the rear wheel supply pressure Pv does not include the friction resistance, thus, there is a difference therebetween. Note that the pressure adjustment state in the pressure adjustment unit CA is any one of the two-system pressure adjustment and the one-system pressure adjustment.

### Other Embodiments

Other embodiments will be described below. Also in other embodiments, the same effect as described above (the smooth pressure adjustment switching from the two-system pressure adjustment to the one-system pressure adjustment, or the like) is achieved.

In the embodiment described above, in the braking control device SC, the front wheel supply pressure sensor PM is built in the lower braking unit SB (in particular, the lower actuator YB). The front wheel supply pressure sensor PM may be built in the upper braking unit SA (in particular, the upper actuator YA). However, the front wheel supply pressure sensor PM is required for each-wheel independent control such as the antilock brake control, and thus it is advantageous to build the front wheel supply pressure sensor PM in the lower braking unit SB in terms of simplifying the entire device. In addition, when the front wheel supply pressure sensor PM is built in the upper braking unit SA, the each-wheel independent control cannot be executed at the time of a communication error. Also in this respect, it is advantageous to build the front wheel supply pressure sensor PM in the lower braking unit SB.

In the embodiment described above, the target values (Fv, Fx, Fh, Fn, and the like) of various braking forces are calculated in a dimension of a longitudinal force acting on the vehicle JV. Alternatively, the calculation may be performed using the dimension of the deceleration of the vehicle JV or the dimension of the torque of the wheel WH. This is based on a matter that state quantities from the longitudinal force to the deceleration of the vehicle (referred to as “force-related state quantities”) are equivalent. Therefore, the target pressures Ptf, Ptr, Px are calculated based on the force-related state quantities from the longitudinal force acting on the vehicle JV to the deceleration of the vehicle JV.

In the embodiment described above, examples of the pressure adjustment unit CA include one (a so-called reflux type configuration) that adjusts the front wheel and rear wheel supply pressures Pm, Pv by throttling the circulation flow KN of the braking liquid BF discharged from the fluid pump QA by the upstream side and downstream side pressure adjustment valves UJ, UK. Alternatively, in the pressure adjustment unit CA, the front wheel and rear wheel supply pressures Pm, Pv may be adjusted based on the pressure accumulated in the accumulator (a so-called accumulator type configuration). A volume in the cylinder may be increased or decreased by the piston directly driven by the electric motor, and the front wheel and rear wheel supply pressures Pm, Pv may be adjusted (a so-called electric cylinder type configuration).

In the embodiment described above, the pressure receiving area rm (the master area) of the master chamber Rm and the pressure receiving area ru (the servo area) of the servo chamber Ru are set equal to each other in the applying unit AP. The master area rm and the servo area ru do not have to be equal. In a configuration in which the master area rm and the servo area ru are different, a conversion calculation between the front wheel supply pressure Pm and the downstream side servo pressure Pk (or the upstream side servo pressure Pj) can be performed based on the ratio of the servo area ru to the master area rm (that is, the conversion based on “Pm·rm=Pk·ru (or Pj·ru)”).

In the braking control device SC, in the transmission passage of the front wheel and rear wheel supply pressures Pm, Pv, the fluid passage (which is a movement passage of the braking liquid BF and referred to as the “communication passage”) connects a portion where the front wheel supply pressure Pm acts and a portion where the rear wheel supply pressure Pv acts. A normally open type solenoid valve (referred to as a “communication valve”) is provided in the communication passage. In the case of the two-system pressure adjustment, the communication valve is closed and the communication passage is blocked. Accordingly, the front wheel and rear wheel supply pressures Pm, Pv are individually adjusted. On the other hand, in the case of the one-system pressure adjustment, the communication valve is opened, and the portions related to the front wheel and rear wheel supply pressures Pm, Pv are communicated. Accordingly, the front wheel and rear wheel supply pressures Pm, Pv are adjusted with the same liquid pressure. Here, the portions (referred to as “acting portions”) where the front wheel and rear wheel supply pressures Pm, Pv act correspond to portions such as generation sources of the front wheel and rear wheel supply pressures Pm, Pv, and the transmission passage (the fluid passage, the liquid pressure chamber). The acting portions include not only the portions where the front wheel and rear wheel supply pressures Pm, Pv directly act, but also portions where the forces generated by the front wheel and rear wheel supply pressures Pm, Pv act via the member (for example, the master piston NM). For example, in the configuration shown in FIG. 2, the portions pj, pk correspond to the acting portions, and the upstream side pressure adjustment valve UJ corresponds to the communication valve. Here, the rear wheel supply pressure Pv directly acts on the portion pj, but the front wheel supply pressure Pm indirectly acts on the portion pk via the master piston NM.

### <Summary of Embodiments>

Hereinafter, the embodiments of the braking control device SC will be summarized. The braking control device SC is a brake-by-wire device capable of independently adjusting the liquid pressures Pwf, Pwr (front wheel and rear wheel pressures) of the front wheel and rear wheel cylinders CWf, CWr according to the braking required amount Bs.

The braking control device SC includes the applying unit AP, the pressure adjustment unit CA, the controller EA, the front wheel supply pressure sensor PM, and the rear wheel supply pressure sensor PV. The applying unit AP includes the cylinder CM, and the supply chamber Rm (master chamber) and the servo chamber Ru partitioned by the piston NM inserted into the cylinder CM. Here, the supply chamber Rm and the servo chamber Ru are sealed by the seal member SL.

The first and second servo pressures P1, P2 are electrically adjusted by the pressure adjustment unit CA. For example, the first and second servo pressures P1, P2 are generated using the electric motor as a power source. The first servo pressure P1 is supplied to the servo chamber Ru. Accordingly, the front wheel supply pressure Pm is output from the supply chamber Rm to the front wheel cylinder CWf. That is, the front wheel supply pressure Pm is adjusted by the first servo pressure P1, and the front wheel pressure Pwf is adjusted by the front wheel supply pressure Pm. Therefore, the front wheel pressure Pwf is adjusted by the first servo pressure P1.

The second servo pressure P2 is directly output to the rear wheel cylinder CWr as the rear wheel supply pressure Pv. That is, the rear wheel supply pressure Pv is adjusted by the second servo pressure P2, and the rear wheel pressure Pwr is adjusted by the rear wheel supply pressure Pv. Therefore, the rear wheel pressure Pwr is adjusted by the second servo pressure P2. In the controller EA, any one of the two-system pressure adjustment for individually adjusting the first and second servo pressures P1, P2 and the one-system pressure adjustment for adjusting the first and second servo pressures P1, P2 to be the same is selected. The front wheel and rear wheel supply pressures Pm, Pv are detected by the front wheel and rear wheel supply pressure sensors PM, PV.

In the controller EA, if the two-system pressure adjustment is selected, the front wheel and rear wheel target pressures Ptf, Ptr are individually calculated based on the braking required amount Bs. The pressure adjustment unit CA is controlled such that the front wheel and rear wheel supply pressures Pm, Pv coincide with the front wheel and rear wheel target pressures Ptf, Ptr. Specifically, the first and second servo pressures P1, P2 are controlled such that the front wheel and rear wheel supply pressures Pm, Pv coincide with the front wheel and rear wheel target pressures Ptf, Ptr. In the two-system pressure adjustment, the front wheel target pressure Ptf and the rear wheel target pressure Ptr are different from each other, and thus the first servo pressure P1 and the second servo pressure P2 are adjusted to be different from each other. As a result, the front wheel supply pressure Pm and the rear wheel supply pressure Pv are different from each other, and the front wheel pressure Pwf and the rear wheel pressure Pwr are different from each other.

On the other hand, if the one-system pressure adjustment is selected, the common target pressure Px is calculated. The common target pressure Px is determined by making the front wheel and rear wheel target pressures Ptf, Ptr equal and further adding the predetermined pressure ps. The pressure adjustment unit CA is controlled such that the rear wheel supply pressure Pv coincides with the common target pressure Px. Specifically, the first and second servo pressures P1, P2 are controlled such that the rear wheel supply pressure Pv coincides with the common target pressure Px. Note that the predetermined pressure ps is a predetermined value (constant) corresponding to the sliding resistance of the seal member SL and is set in advance. In the one-system pressure adjustment, the front wheel target pressure Ptf and the rear wheel target pressure Ptr are equal, and the first servo pressure P1 and the second servo pressure P2 are adjusted to be equal. As a result, the front wheel supply pressure Pm and the rear wheel supply pressure Pv become equal, and the front wheel pressure Pwf and the rear wheel pressure Pwr become equal. However, there is a difference in the friction resistance of the seal member SL.

The first servo pressure P1 is transmitted to the front wheel cylinder CWf as the front wheel supply pressure Pm via the cylinder CM and the piston NM. On the other hand, the second servo pressure P2 is directly transmitted to the rear wheel cylinder CWr as the rear wheel supply pressure Pv without passing through the cylinder CM and the piston NM. The cylinder CM and the piston NM are sealed by the seal member SL, and the front wheel supply pressure Pm is affected by the sliding resistance of the seal member SL, but the rear wheel supply pressure Pv is not affected.

In the braking control device SC, a signal of the rear wheel supply pressure Pv is employed for the one-system pressure adjustment. In this configuration, when the two-system pressure adjustment is switched to the one-system pressure adjustment (at the time of the pressure adjustment switching), a change (in particular, a decrease) in the front wheel pressure Pwf occurs. This is because the control on the front wheel pressure Pwf shifts from one that is controlled by the front wheel supply pressure Pm, which includes the sliding resistance of the seal member SL, to one that is controlled by the rear wheel supply pressure Pv, which does not include the sliding resistance. In the braking control device SC, the influence of the sliding resistance is reduced by adding the predetermined pressure ps to the target pressure Px (the common target pressure) of the one-system pressure adjustment. Accordingly, the change in the front wheel pressure Pwf generated at the time of the pressure adjustment switching is prevented.

At the time of the pressure adjustment switching, the change in the front wheel pressure Pwf is prevented, but a change occurs in the rear wheel pressure Pwr. However, in the braking force of the entire vehicle (result, the deceleration of the vehicle JV), the influence of the front wheel braking force is much larger than the influence of the rear wheel braking force. Therefore, a change in the rear wheel braking force due to a change in the rear wheel pressure Pwr has a slight influence on the entire vehicle. Therefore, in the entire vehicle, the switching from the two-system pressure adjustment to the one-system pressure adjustment is performed smoothly using the common target pressure Px to which the predetermined pressure ps (for example, a value corresponding to the sliding resistance of the seal member SL) is added.

The pressure adjustment switching based on the common target pressure Px is particularly effective when the execution of the antilock brake control is started and the two-system pressure adjustment is switched to the one-system pressure adjustment. This is because the antilock brake control is started in the course of a series of braking operations, and thus the driver can easily notice a change in the wheel pressure Pw.

1. A vehicle braking control device which adjusts liquid pressures of front wheel and rear wheel cylinders according to a braking required amount, the vehicle braking control device comprising:
an applying unit including a cylinder, and a supply chamber and a servo chamber partitioned by a piston inserted into the cylinder and sealed by a seal member;
a pressure adjustment unit configured to electrically adjust first and second servo pressures, adjust the liquid pressure of the front wheel cylinder by supplying the first servo pressure to the servo chamber and outputting a front wheel supply pressure from the supply chamber to the front wheel cylinder, and adjust the liquid pressure of the rear wheel cylinder by outputting the second servo pressure to the rear wheel cylinder as a rear wheel supply pressure;
front wheel and rear wheel supply pressure sensors configured to detect the front wheel and rear wheel supply pressures respectively; and
a controller configured to select any one of a two-system pressure adjustment for individually adjusting the first and second servo pressures, and a one-system pressure adjustment for adjusting the first and second servo pressures to be the same, wherein
the controller is configured to
in response to selection of the two-system pressure adjustment, individually calculate front wheel and rear wheel target pressures based on the braking required amount, and control the pressure adjustment unit such that the front wheel and rear wheel supply pressures coincide with the front wheel and rear wheel target pressures, and
in response to selection of the one-system pressure adjustment, make the front wheel and rear wheel target pressures equal and then add a predetermined pressure to calculate a common target pressure, and control the pressure adjustment unit such that the rear wheel supply pressure coincides with the common target pressure.

2. The vehicle braking control device according to claim 1, wherein
the predetermined pressure is set to a value corresponding to sliding resistance of the seal member.

3. The vehicle braking control device according to claim 2, wherein
the controller switches the two-system pressure adjustment to the one-system pressure adjustment at a time point when execution of an antilock brake control is started.

4. The vehicle braking control device according to claim 1, wherein
the controller switches the two-system pressure adjustment to the one-system pressure adjustment at a time point when execution of an antilock brake control is started.
